(19) United States
(12) Patent Application Publication
(10) Pub. No.: US 2009/0328205 A1
(43) Pub. Date: Dec. 31, 2009

(54) USER ESTABLISHED GROUP-BASED SECURITY FOR USER CREATED RESTFUL RESOURCES

(75) Inventors: STEVEN Dale IMS, APEX, NC (US); DANIEL Everett JEMIOLO, CARY, NC (US); TODD Erick KAPLINGER, RALEIGH, NC (US); BRETT Graham KING, APEX, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/110,751

(22) Filed: Apr. 28, 2008

(51) Int. Cl. G06F 21/00; G06F 11/00

(52) U.S. Cl. 726/22

(57) ABSTRACT

A system for securing user created Web resources that includes a data store and a URI security engine. The data store can store digitally encoded content comprising a set of user created, URI identified resources. The URI security engine can provide declarative instance based URI access control to the user created URI identified resources. The URI security engine can apply semantics of user/group control for accessing the URI identified resource. These controls can be group controlled based upon deployer (creator) established privileges rather than being based upon an explicit developer established privileges, which may not be possible since the resources can be deployer (end-user) created resources not existing at development time.

### BACKGROUND OF THE INVENTION

The present invention relates to the field of group-based security, more particularly, to user established group-based security for user created Representational State Transfer (REST) based (or RESTful) resources.

Instance based security has long been a problem for many enterprises to both implement and configure. A typical usage scenario is where a user can be authenticated and authorized to view a particular resource (i.e., account info page), but only that user's account info should be available to them. Typically, in a scenario like this, every user accesses their account information on the same Uniform Resource Identifier (URI). A language interpreter can be used to distinguish different users and provide their account information. A security definition has not historically been defined based upon the URI since the URI alone does not provide enough information to determine the user.

Most JAVA 2 PLATFORM, ENTERPRISE EDITION (J2EE) application developers create a custom security implementation to handle this scenario since J2EE based applications do not provide a flexible way for defining security rules outside of URIs and ROLES, which are not adequate for this pattern. For the case that the URI space is well defined and limited where the URI can indicate the user, this can be handled via explicit configuration for each URI combination. However, this configuration can be time consuming, error prone, and does not scale well when there is an excess of URIs to be secured. A custom code solution can be implemented in this situation, can also be error prone and time consuming, therefore costly. Additionally, a custom code solution must have a set of predefined developer resources, as opposed to user designed ones, which is the case with many Web 2.0 objects (e.g., Blogs, Mashups, Folksonomies, Social networking pages, Wikis, etc.). Thus, custom code solutions have not been successfully implemented for customer created URI addressable content (e.g., Web 2.0 content).

Representational State Transfer (REST) is a style of software architecture that strictly refers to a collection of network architecture principles, which outline how resources are defined and addressed. The term is commonly used to describe any simple interface, which transmits domain-specific data over hypertext transfer protocol (HTTP) without an additional messaging layer such as Simple Object Access Protocol (SOAP) or session tracking via HTTP cookies. A RESTful resource can be a resource that is addressed via its URI. In more recent Web applications, RESTful resources can be created on-the-fly using names and values supplied by the user. One example can be a social networking application that allows users to create a list of contacts, for example, at http://mysite.com/profiles/{user-id}/friends, where {user-id} is the user's ID. In this scenario, contacts the user ID “bob” has added would be viewable at http://mysite.com/profiles/bob/friends. The application developer has no idea what the user IDs will be, neither will they know what kind of privacy concerns the user will have, so creating authorization rules to fit each user's preferences would be impossible. Even in the case where the application developer knows the user's preferences and ID's, the amount of work required to specify individual rules for every resource would not be feasible. A significant amount of Web 2.0 content is based upon RESTful techniques.

### BRIEF SUMMARY OF THE INVENTION

One aspect of the present invention can include a method, apparatus, computer program product, and system for securing a software resource. In this aspect, a resource associated with a Uniform Resource Identifier (URI) can be identified. An attempt to access the resource by a user can be detected. A data store can be queried using the URI to determine a group-based relationship between the user and a resource owner and to determine an access level based upon previously established group based security settings and the group-based relationship. The determined access level can be granted to the user for the resource.

Another aspect of the present invention can include a system for securing user created Web resources that includes a data store and a URI security engine. The data store can store digitally encoded content comprising a set of user created, URI identified resources. The URI security engine can provide declarative instance based URI access control to the user created URI identified resources. The URI security engine can apply semantics of user/group control for accessing the URI identified resource. These controls can be group controlled based upon deployer (creator) established privileges rather than being based upon an explicit developer established privileges, which may not be possible since the resources can be deployer (end-user) created resources not existing at development time.

### BRIEF DESCRIPTION OF THE SEVERAL VIEWS OF THE DRAWINGS

FIG. 1 is a schematic diagram of a system for user established group-based security for user created RESTful resources in accordance with an embodiment of the inventive arrangements disclosed herein.

FIG. 2 is a diagram of a scenario for user established group-based security for user created RESTful resources in accordance with an embodiment of the inventive arrangements disclosed herein.

FIG. 3 is a flow chart of a method for user established group-based security for user created RESTful resources in accordance with an embodiment of the inventive arrangements disclosed herein.

### DETAILED DESCRIPTION OF THE INVENTION

The present invention can simplify security configuration of Representational State Transfer (REST) based or RESTful resources by allowing a user to control group-based security for their resources. The present invention can allow users to create security rules for RESTful resources they have created. The security rules they create can be based on groups. That is, users can be classified into groups and permissions can be granted, or revoked, based upon the groups. For example, on a social networking site, a user has created their own profile. In this profile, the user can specify that some of their contacts are in their “work” group, others are in their “family” group, and an “everyone” group that includes everyone that is not in another group. The present invention can allow the user to specify that people in the “everyone” group are not granted any access to their RESTful resource. The user can also allow the user to grant full read, write, and modify permissions to the “family” group while granting only read permissions to the “work” group.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times, code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

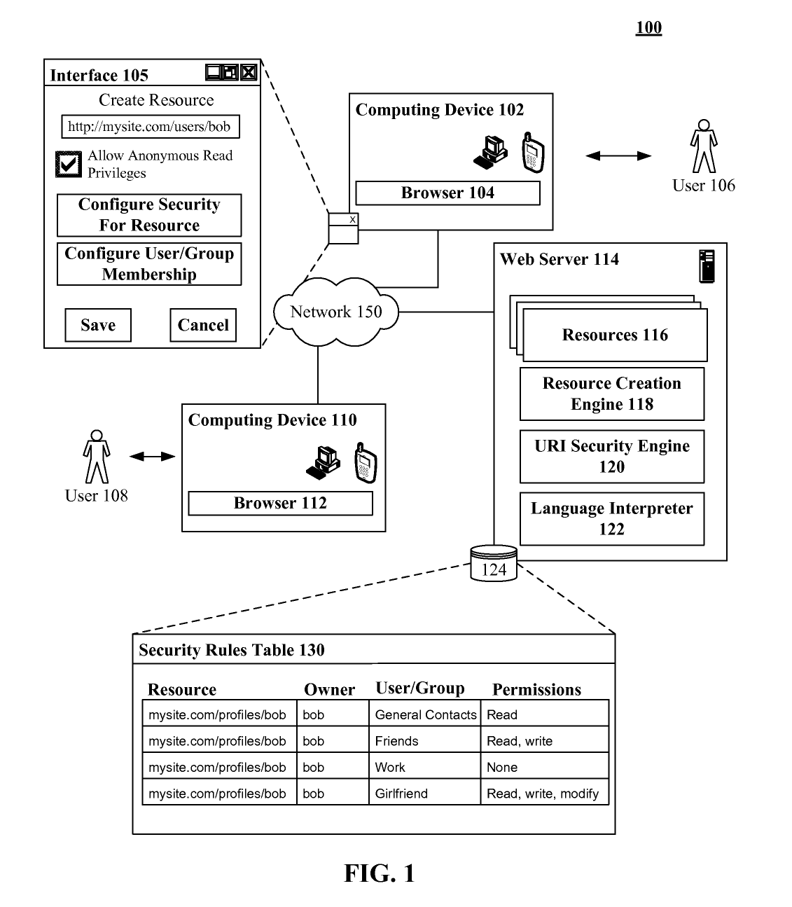

FIG. 1 is a schematic diagram of a system 100 for user established group-based security for user created RESTful resources in accordance with an embodiment of the inventive arrangements disclosed herein. A RESTful resource can be a resource that is addressed via its Uniform Resource Identifier (URI). In one embodiment, the security can include user 106, 108 defined security, which is added to Web 2.0 content at content creation time. Web 2.0 content refers to content able to be created and shared by and among a set of Web users. Group based security is believed to be strong fit for securing user defined RESTful resources, as it is intuitive for most users 106, 108 who are familiar with group based security of files in a networking context. Group based security also maps well to RESTful primitives of GET, PUT, POST, and DELETE that are basic access privileges that can be established per user or group, as defined by a content owner in accordance with a group based security scheme.

In system 100, user 106 can use interface 105 on computing device 102 to interface with resource creation engine 118 in Web server 114 to create a resource 116. User 106 can also use browser 104 to interact with Web server 114 and establish security policies to be applied for their created resource 116 by URI security engine 120. The security engine 120 permits different groups to be defined by user 106 and different permissions to be associated with each group. Each user 106, 108 able to own a resource 116 can have a user-specific set of groups established. A relationship between an accessing user 108 and a resource owner 106 can be one used to define which groups and associated group/user permissions apply to a given resource 116. Thus, the URI security engine 120 relies upon semantics of user/group control rather than upon explicit configurations. Permissions can be applied based solely upon a URI of a resource 116 and an identity of a user accessing the resource. A resource owner, who is important when determining a relationship and which user/group the user attempting to access belongs to, can be associated with the URI. Each resource owner can have a user specific relationship matrix associated with it, where the relationship matrix comprises a set of configurable records used to define a group to which an accessing user belongs.

For example, groups defined for a URI identified resource shown in table 130 includes Everyone, Friends, Work, and Girlfriend. Each user 106 is permitted to establish customized groups and/or to utilize a set of previously established groups based upon definable criteria. For instance, friends can be defined in a social networking context to include a set of people with whom “significant” interactions occur, where significant interactions are defined by programmatic rules. In another example, the groups can be based upon groupings established within a users contact management system, IM communication system, or other application. Further, a profile accessible by server 114 and specific to users 106 who have created resources can be used for defining groups and for determining membership within a group.

Once group security has been established, other users 108 access to a given resource 116 can be based upon these settings. Group membership can depend upon a relationship with an accessing user 108 and a resource owner 106. Hence, when different users 108 attempt to access a URI defined resource of server 114 via a browser 112 of computing device 110, different permissions are granted. Permissions can include read, write, update, and delete privileges or subsets and derivatives thereof.

For example from table 130, when “friend” accessing a resource identified as “mysite.com/profiles/bob” can be granted read/write permission, while a person belonging to a Work group can have no privileges. It should be noted that general contacts, which can refer to anonymous users of a social networking site and/or identified but unknown parties could have read permissions, while those associated with a work group have more limited permissions (e.g., none). This can effectively help protect a user's ability to interact with a social networking Web site (possibly using a pseudonym, where interior content contains real information linking the pseudonym to the user) while isolating these activities from a user's professional life.

Further, although not shown, different content can be segmented into sub-regions (each identified by a distinct URI, to permit user 106 provided resources to be more tightly controlled than is desired. For example, a user 106 may publish a portion of content to the public, but may want to keep a dialog with a girlfriend private from prying eyes. This can be especially important using network resident content (e.g., content stored in data store 124 and provided by Web server 114) as privacy regarding user 106 created Web 2.0 content is becoming an increasing concern and has historically not been strongly protected.

In one embodiment, the various privilege levels associated with the groups can be adjusted for a specific implementation context and for policies established by the Web server 114. These privilege levels can include non-traditional privileges, or redefinitions of standard privileges suitable for a Web 2.0 context. For example, many social networking sites are supported, at least in part, based upon demographic information data mined from user provided content. An option to “delete” content can be modified to retain the content in an anonymous form, where user specific identifiers have been removed through a sanitation action but where important data points needed for demographic purposes are retained. Thus, a “delete” action able to be implemented can maintain user privacy regarding data, while ensuring a value relating to data driven metrics is retained.

Similarly, an option to add content can be implemented so that the content added, regardless of content creator, is considered to be a resource owned by an original owner of the base resource 116 (as opposed to content owned by the person performing the add action). Since security provided by engine 120 is based upon a relationship between a content owner and an accessing user, the ownership of a resource is important from a security implementation standpoint. Also, the content can be indexed based upon attributes of the original content owner (user 106) as opposed to being based upon attributes of the content adding party (user 108) alone.

As used herein, Representational State Transfer (REST) refers to a style of software architecture that defines how resources 116 are to be defined, accessed, and addressed. A REST resource (e.g., resource 116) can be identified by a URI, which is able to function as a primary key for a resource. RESTful interfaces (e.g., interface 105) can transmit domain-specific data over HTTP without an additional messaging layer such as SOAP or session tracking via HTTP cookies. Additionally, REST architectures divide application state and functionally into resources 116. All resources 116 can share a uniform interface for a transfer of state between clients and resources 116 that includes a constrained set of well-defined operations and a constrained set of content types. RESTful resources can utilize a protocol that is client-server, stateless, cacheable, and layered.

Computing devices 102 and 110 can be capable of permitting a user to interfacing with server 114. Computing devices 102 and 110 can include a variety of computing devices, including, but not limited to, a personal computer, a mobile phone, a personal data assistant (PDA), a gaming console, a kiosk, an embedded computing device, a wearable computing device, a thin client, a Web tablet, and the like.

Each computing device 102 and/or 110 can include a browser component 104 and/or 112. Browsers 104 and 112 are defined broadly to include any computer program product able to interact with a remotely located source of Web content. Web content can include hypertext Markup Language (HTML) based content, dynamically generated script content (e.g., APPLETS) and the like. The browser 102 and/or 110 can include a graphical user interface (GUI), a voice user interface (VUI), a multimodal interface, a text user interface, and the like. Moreover, browsers 102 and/or 110 are to be broadly interpreted to include a rich internet interface (RII) and a REST client as well as traditional Web browsers (e.g., MOZILLA FIREFOX, INTERNET EXPLORER, OPERA, etc.).

Web server 114 can be include any computing device or set of computing devices configured to serve data via network 150. As shown, Web server 114 can include resources 116, resource creation engine 118, URI security engine 120, language interpreter 122, and data store 124. In one embodiment, the resource creation engine 118 and/or URI security engine can be implemented separately from a server, which provides Web pages. For example, the URI security engine 120 can be implemented within middleware and/or implemented as a Web service provided by a network element communicatively linked to the Web server 114 via network 150.

The URI security engine 120 can utilize any of a variety of encryption techniques to ensure secured data is handled in accordance to user/group based access policies. These techniques can include additional layers of security above the user/group based access policies. For example, users 106, 108 can be required to authenticate themselves using user identifiers and authentication information (e.g., password, a digital certificate, biometric input, etc.) to verify their identify before user/group based permissions for individual resources 116 are applied.

The resource creation engine 118 can be an engine used by Web server 114 to allow users to create new resources to add to resources 116. For example, Web server 114 can be running a social networking site (i.e. MYSPACE, FACEBOOK). In this example, resource creation engine 118 can allow the user to create a profile on the site. In some embodiments, language interpreter 122 can be required to interpret and execute resource creation engine 118. Resource creation engine 118 can provide interfaces, such as interface 105, to users to allow the creation and/or modification of resources.

The URI security engine 120 can allow the securing of resources 116. When a URI request is sent to Web server 114, URI security engine 120 can evaluate security policies stored on data store 124 regarding the requested URI. Security rules table 130 illustrates security policies regarding resources 116. Such rules can relate to the user's associated group and designate read, write, and modify access to resources 116.

The language interpreter 122 can be a component in which can interpret and execute code that is not natively executable. Language interpreter 122 can be used to interpret Web scripts that reside on Web server 114. In some embodiments, URI security engine 120 and resource creation engine 118 can require language interpreter 122. For example, URI security engine 120 can require information in a user's session in which is established with a script being run. Resource creation engine 118 can be created in a language in which requires language interpreter 122 to execute.

Network 150, which connects the devices 102, 110, and server 110 to each other, can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers, which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

The information managed by server 114 and device(s) 102, 110 can be stored in a one or more data stores, which includes data store 124. These data stores can be a physical or virtual storage spaces configured to store digital information. The data stores can be physically implemented within any type of hardware including, but not limited to, a magnetic disk, an optical disk, a semiconductor memory, a digitally encoded plastic memory, a holographic memory, or any other recording medium. Each of data stores can be a stand-alone storage unit as well as a storage unit formed from one or more physical devices. Additionally, information can be stored within the data stores in a variety of manners. For example, information can be stored within a database structure or can be stored within one or more files of a file storage system, where each file may or may not be indexed for information searching purposes. Further, the data stores can optionally utilize one or more encryption mechanisms to protect stored information from unauthorized access.

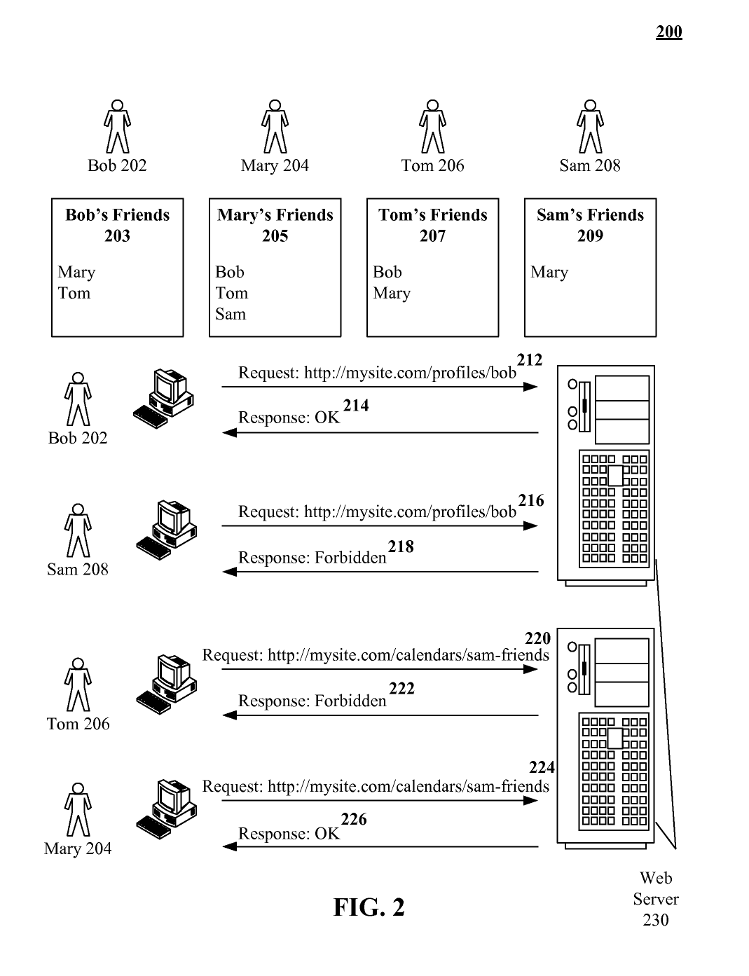

FIG. 2 is a diagram 200 of a scenario for user established group-based security for user created RESTful resources in accordance with an embodiment of the inventive arrangements disclosed herein. Diagram 200 can be performed in a context of system 100. Diagram 200 provides a sample use case of user/group based permissions dependent upon URIs, which is prevented for illustrative purposes only and is not to be construed as a scope limitation.

As shown in diagram 200, a set of users (e.g., Bob 202, Mary 204, Tom 206, and Sam 208) can each be owners of one or more RESTful resources maintained by Web server 230. These users 202-208 can have also setup security measures on their RESTful resources, which include user 202-208 specific group based, URI controlled security settings. Each user 202-208 has an established friends 203, 205, 207, 209 list. A “friend” can be a label used to designate a security group. In this example, only one security group is shown, but the present invention can allow for any number.

In diagram 200, Bob 202 has added Mary 204 and Tom 206 as friends. Mary 204 has added Bob 202, Tom 206, and Sam 208 as friends. Tom 206 has added Bob 202 and Mary 204 as friends. Sam 208 has added Mary 203 as a friend.

Requests and responses 212-226 show the communications between each user Bob 202, Mary 204, Tom 206, and Sam 208 with Web server 230. Bob 202 can communicate with Web server 230 with request 212. Bob 202 can request http://mysite.com/profiles/bob, which can be his own profile. Web server 230 can establish that Bob 202 is an authorized user of the URI and send response 214 OK to Bob 202 and grant Bob 202 access to the requested URI.

Sam 208 can communicate request 216 to Web server 230. Sam 208 can request Bob 202's profile (http://mysite.com/profiles/bob). Web server 230 can again determine that Bob's profile is a secured resource. Web server 230 can evaluate groups that have permission to access the resource and compare them to Sam 208's affiliated group or groups. Sam 208 is not in Bob's friends group and therefore, Web server 230 responds with response 218 forbidden to Sam 208 and permission to the requested URI is denied.

Tom 206 can communicate request 220 to Web server 230. Tom 206 can request a calendar that is created specifically for Sam 208's friends group (http://mysite.com/calendars/sam-friends). Web server 230 can evaluate the contents of Sam 208's friends group and compare it to the Tom 206's affiliated group. Tom 206 is not in Sam 208's friends group and therefore Web server 230 responds with response 222 forbidden.

Mary 204 can communicate request 224 to Web server 230. Mary 204 can request a calendar that is created specifically for Sam 208's friends group (http://mysite.com/calendars/sam-friends). Web server 230 can compare Sam 208's friends group with the group or groups Mary 204 is affiliated with. Mary 204 is in Sam 208's friends group and therefore, Web 230 can send response 226 OK and grant Mary 204 access to the requested URI.

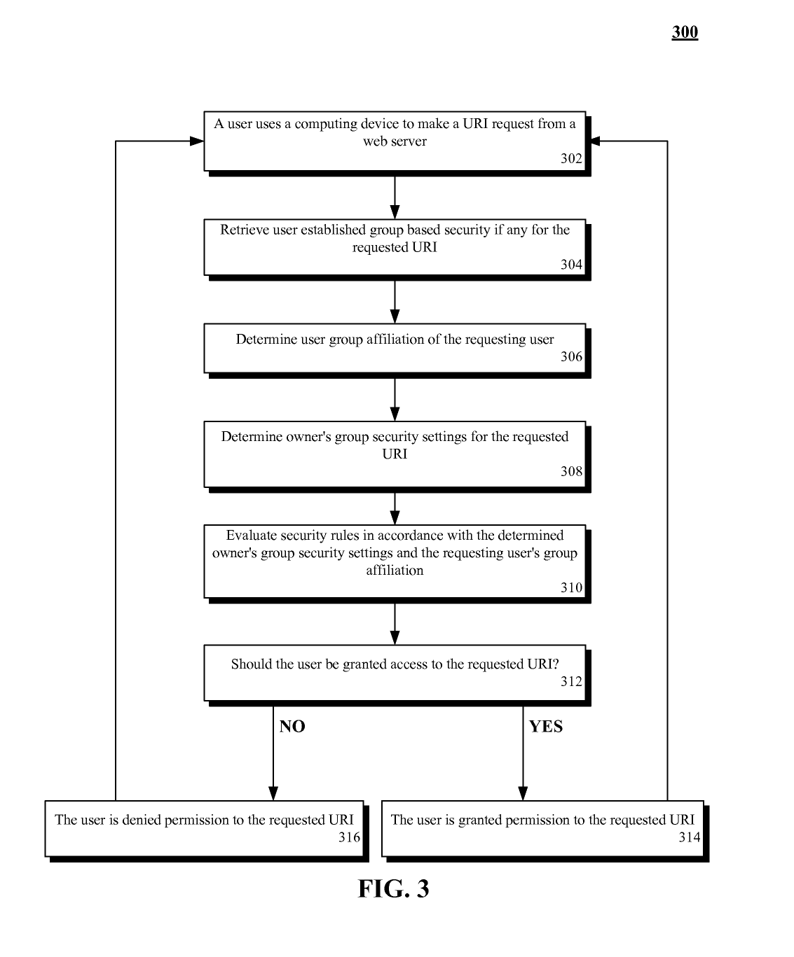

FIG. 3 is a flow chart of a method 300 for user established group-based security for user created RESTful resources in accordance with an embodiment of the inventive arrangements disclosed herein. Method 300 can be performed in context of system 100.

Method 300 can begin in step 302, where a user can use a computing device to make a URI request from a Web server. In step 304, the Web server can retrieve user established group based security settings for the requested URI, if there are any. In step 306, the Web server can determine user group affiliations of the requesting user. In this step, the Web server can prompt the requesting user for authentication credentials to verify the user's identity. In step 308, the Web server can determine the owner's group security settings for the requested URI. In step 310, the Web server can evaluate the security rules in accordance with the owner's group security settings and the requesting user's group affiliation. In step 312, the Web server can determine if the requesting user should be granted access to the requested URI. If in step 312, the user should be granted access, method 300 can continue to step 314 where the user is granted permission to the requested URI. If in step 312, the user should not be granted access, method 300 can continue to step 316, where the user is denied permission to the requested URI. After steps 314 and 316, method 300 can loop back to step 302 where the process can begin again.

The diagrams in FIG. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for securing a software resource comprising:
identifying a resource associated with a Uniform Resource Identifier (URI), wherein the resource is dynamically created by a resource owner, and wherein the URI is created when the dynamic resource is created and wherein at least a portion of said URI uniquely corresponds to the resource owner;
detecting an attempt to access said resource by a user other than the end-user who dynamically created said resource;
querying a data store using said URI to determine a group-based relationship between the user and the resource owner and to determine an access level based upon previously established group based security settings and the group-based relationship; and
granting said determined access level to said user for said resource.

2. The method of claim 1, wherein said resource is a REST based resource maintained and served by a network server, which is operated by an entity independent of said user and said resource owner, and wherein the resource owner and said user are end-users.

3. The method of claim 2, wherein said network server is a WEB 2.0 server, and wherein said REST based resource is at least one of a BLOG, WIKI, MASHUP, FOLKSONOMY, and a social networking resource.

4. The method of claim 2, wherein access level defined by said group based security setting comprises a read, an update, an add, and a delete access level setting.

5. The method of claim 1, further comprising:
the user dynamically creating said resource; and
the user assigning group based security settings for said resource.

6. The method of claim 5, wherein said resource comprises Web content for a social networking site, wherein said resource provides personal data established by said resource owner that is related to an identity that said resource owner has established with the social networking site.

7. The method of claim 1, further comprising:
serving at least one content creation Web page to the resource owner, wherein said content creation Web page is browser render-able and permits said resource owner to define a dynamic resource, wherein said resource owner is a user of a Web site able to create the dynamic resource via the content creation Web page which is thereafter accessible by other users of the Web site.

8. The method of claim 7, wherein the Web site is a Web 2.0 Web site and wherein the dynamic resource is a REST based resource.

9. The method of clam 8, wherein the content creation Web page comprises user interface elements for inputting group based permissions and group based access levels for said REST based resource, said method further comprising:
receiving user provided input entered into said content creation Web page, wherein said user provided input comprises at least one group value and at least one access level value for said group; and
storing said group value and said access level value in a database record, wherein said data based record includes a URI attribute, wherein said URI attribute is at least one of a primary key and a foreign key of a relational database comprising said database record.

10. The method of claim 1, wherein said group based security settings comprise an owner established read access setting for said resource and an owner established update access setting for said resource.

11. The method of claim 1, wherein said data store comprises a plurality of user established resources, each having an associated URI, wherein each user established resource is internally represented by an user identifier, wherein each user having a user identifier has user specific group settings, which define which other users are to be considered within which groups based upon relationships specific to said other users and said user associated with the user specific group settings.

12. A computer program product for securing a software resource, the computer program product comprising:
a computer usable medium having computer usable program code embodied therewith, the computer usable program code comprising:
computer usable program code configured to identify a resource associated with a Uniform Resource Identifier (URI), wherein the resource is dynamically created by a resource owner, and wherein the URI is created when the dynamic resource is created and wherein at least a portion of said URI uniquely corresponds to the resource owner;
computer usable program code configured to detect an attempt to access said resource by a user;
computer usable program code configured to query a data store using said URI to determine a group-based relationship between the user and the resource owner and to determine an access level based upon previously established group based security settings and the group-based relationship; and
computer usable program code configured to grant said determined access level to said user for said resource.

13. The computer program product of claim 12, wherein the Web site is a Web 2.0 Web site, and wherein the dynamic resource is a REST based resource, and wherein the resource owner and said user are end-users.

14. The computer program product of claim 13, wherein the content creation Web page comprises user interface elements for inputting group based permissions and group based access levels for said REST based resource, said computer program product further comprising:
computer usable program code configured to receive user provided input entered into said content creation Web page, wherein said user provided input comprises at least one group value and at least one access level value for said group; and
computer usable program code configured to store said group value and said access level value in a database record, wherein said data based record includes a URI attribute, wherein said URI attribute is at least one of a primary key and a foreign key of a relational database comprising said database record.

15. The computer program product of claim 12, further comprising:
computer usable program code configured to dynamically create the resource responsive to user interactions; and
computer usable program code configured assign group based security settings for said dynamically created resource based upon user provided input.

16. The system for securing user created Web resources comprising
a data store configured to store digitally encoded content comprising a plurality of user created, URI identified resources; and
a URI security engine configured to provide declarative instance based URI access control to said user created URI identified resources, wherein said URI security engine is configured to apply semantics of user/group control for accessing said URI identified resource.

17. The system of claim 16, wherein said semantics of user/group control apply to said URI identified resources based upon a relationship between a resource accessing user and a resource owner.

18. The system of claim 16, wherein said data store comprises a plurality of user specific relationship records, wherein said relationship records define a plurality of relationships existent between a user for whom the user specific relationship records relates and a plurality of other users, wherein said URI security engine is configured to utilize said user specific relationship records to a relationship existing between an owner of one of said URI identified resources and a user attempting to access the URI identified resource.

19. The system of claim 16, further comprising:
a resource creation engine configured to permit said plurality of users to create at least a portion of said URI identified resources.

20. The system of claim 19, wherein URI security engine permits said plurality of users to configure group based security settings for URI identified resources for which each user is considered an owner.
